(19) United States
(12) Patent Application Publication
(10) Pub. No.: US 2010/0235789 A1
(43) Pub. Date: Sep. 16, 2010

(54) DISPLAY CONTROL SYSTEM AND METHOD

(75) Inventor: SHOU-MING LIANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/422,207

(22) Filed: Apr. 10, 2009

(30) Foreign Application Priority Data
Mar. 13, 2009 (CN) 200910300822.0

(51) Int. Cl. H04L 9/32; G06F 21/00; G06F 3/048

(52) U.S. Cl. 715/811; 726/19

(57) ABSTRACT

A display control system includes a memory system and an identifying control unit. The memory system is configured to store an identification code for an authorized operator of the display control system and an associated function interface for the authorized operator. The associated function interface comprises commonly used functions of the authorized operator, and an identification code of each authorized operators. The identifying control unit configured to receive and identify the identification code from the authorized user, invoke an instruction corresponding to the identification code from the memory system to generate the associated function interface, and control a display of the display control system to display the associated function interface.

### BACKGROUND

1. Technical Field

The present disclosure relates to control systems and control methods, and more particularly, to a display control system and method.

2. Description of Related Art

Numerical control devices are generally operated via a plurality of function interfaces. These function interfaces may vary from operator to operator because each function interface is independent. When an operator accesses a numerical control device, the numerical control device may have to change from a present function interface used by a previous operator to another function interface for the new operator, which results in a delay.

### BRIEF DESCRIPTION OF THE DRAWINGS

FIG. 1 is a block diagram of an exemplary embodiment of a display control system connected to a display of a device.

FIG. 2 is a flowchart of an exemplary embodiment of a display control method of the display control system of FIG. 1.

### DETAILED DESCRIPTION

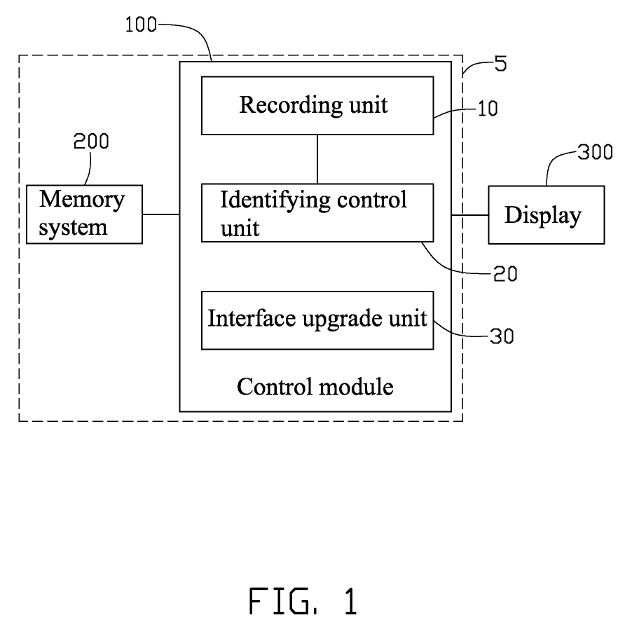

Referring to FIG. 1, an exemplary embodiment of a display control system 5 (hereinafter, “the control system 5”) is disclosed for controlling display of an associated tailored function interface from a plurality of tailored function interfaces. When an authorized operator logs into a device system, such as a numerical control device, the control system 5 controls the device system to display the associated tailored function interface previously associated with the authorized operator. The control system 5 includes a control module 100 connected to a display 300 of the device and a memory system 200. The control module 100 includes a recording unit 10, an identifying control unit 20, and an interface update unit 30.

The memory system 200 is configured to store a plurality of instructions for generating a plurality of function interfaces respectively tailored for and associated with authorized operators, and an identification code for each authorized operator. Each identification code corresponds to an instruction for generating one corresponding tailored function interface. Each tailored function interface includes commonly used functions of the corresponding authorized operator.

The display 300 is controlled to display a login interface for an authorized operator to input an identification code, then display an associated tailored function interface of the authorized operator. When an identification code is input, an instruction corresponding to the identification code is invoked, then the corresponding tailored function interface of the authorized operator is generated to be displayed on the display 300. In some embodiments, the commonly used functions of the authorized operator may be arranged on the display 300 according to placement of the authorized operator. In one example, if the authorized operator prefers have function A be arranged on the left of the display 300, the control system 5 may always display function A on the left of the display 300 for the authorized operator.

The recording unit 10 is configured to record functions used by an authorized operator and count how many times the recorded functions were used, to determine commonly used functions of the authorized operator. In one embodiment, if a function is used more than three times by an authorized operator during one shift, the function is determined to be a commonly used function of the authorized operator and can be automatically included on the tailored function interface at next login of the authorized operator as detailed below in the description of the interface update unit 30. It should be noted that an authorized operator is not limited to functions that first appear on their function interfaces at login, but can access any other functions if desired. Further, seldom used functions of a tailored function interface could be omitted at next login.

The identifying control unit 20 is configured to identify an identification code input by an authorized operator, invoke an instruction corresponding to the input identification code from the memory system 200 to generate a corresponding tailored function interface, and control the display 300 to display the tailored function interface associated with that authorized operator.

The interface update unit 30 is configured to tailor the function interfaces according to authorized operators use as recorded by the recording unit 10, and arrange the commonly used functions on the tailored function interface. Commonly used functions are selected according number of times used over a predetermined number of times in a predetermined period, and wherein selected functions from the commonly used functions are omitted when the selected functions are used less than a predetermined number of times in the period. The updating can occur at log out of an operator. Other parameters may be used to activate updating such as failing to follow scheduled use.

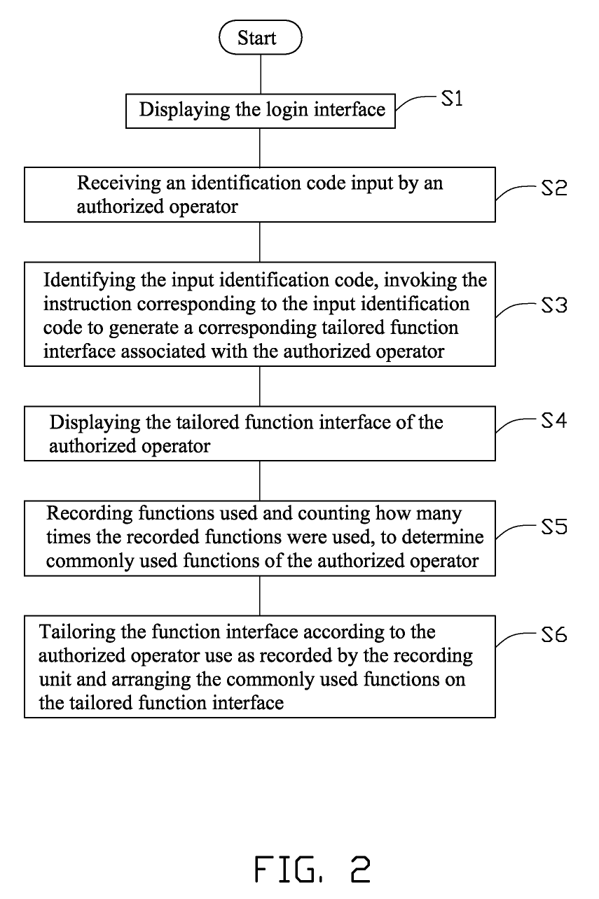

Referring to FIG. 2, an exemplary display control method using the above-mentioned control system 5 includes the follow steps.

In step 1, the display 300 displays the login interface.

In step 2, the login interface receives an identification code input by an authorized operator.

In step 3, the identify control unit 20 identifies the identification code input in the login interface, invokes the instruction corresponding to the input identification code from the memory system 200 to generate a corresponding tailored function interface associated with the authorized operator.

In block 4, the display 300 displays the tailored function interface of the authorized operator.

In block 5, the recording unit 10 records functions used by the authorized operator and counts how many times the recorded functions were used, to determine commonly used functions of the authorized operator.

In block 6, the interface update unit 30 tailors the function interface according to the authorized operator use as recorded by the recording unit 10 and arrange the commonly used functions on the tailored function interface. The commonly used functions are selected according number of times used over a predetermined number of times in a predetermined period, and wherein selected functions from the commonly used functions are omitted when the selected functions are used less than a predetermined number of times in the period.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A display control system for controlling display function interfaces, the display control system comprising:
a memory system configured to store an identification code for an authorized operator of the display control system and an associated function interface for the authorized operator, wherein the associated function interface comprises commonly used functions of the authorized operator; and
an identifying control unit configured to receive and identify the identification code from the authorized user, invoke an instruction corresponding to the identification code from the memory system to generate the associated function interface, and control a display of the display control system to display the associated function interface.

2. The display control system of claim 1, further comprising:
a recording unit configured to record functions used by the authorized operator and count how many times the recorded functions were used, to determine the commonly used functions of the authorized operator; and
an interface update unit configured to arrange the commonly used functions on the associated function interface.

3. The display control system of claim 2, wherein the commonly used functions are selected according number of times used over a predetermined number of times in a predetermined period, and wherein selected functions from the commonly used functions are omitted when the selected functions are used less than the predetermined number of times in the period.

4. A display control method of a device system, the method comprising:
displaying a login interface;
receiving an identification code input by an authorized operator;
identifying the identification code, and invoking an instruction corresponding to the identification code from a memory system of the device system according to the identified identification code, to generate a corresponding tailored function interface of the authorized operator;
displaying the tailored function interface on a display of the device system;
recording functions used and counting operating times of the recorded functions, to determine commonly used functions of the authorized operator; and
tailoring the function interface according to the commonly used functions of the authorized operator.

5. The method of claim 4, wherein the commonly used functions are selected according number of times used over a predetermined number of times in a predetermined period, and wherein selected functions from the commonly used functions are omitted when the selected functions are used less than the predetermined number of times in the period.

6. A display control system, comprising:
a memory system that stores an identification code for an authorized operator of the display control system, and a tailored function interface for the authorized operator corresponding to the identification code, wherein the tailored function interface comprises commonly used functions of the authorized operator;
an identifying control unit configured for receiving an operator identification of the authorized operator, determining the commonly used functions of the authorized operator based at least partly on frequency of use of a plurality of functions of the display control system, generating the tailored function interface based at least partly on the commonly used functions, and controlling a display of the display control system to display the tailored function interface to the authorized operator.
